(19) United States
(12) Patent Application Publication
(10) Pub. No.: US 2025/0103864 A1
(43) Pub. Date: Mar. 27, 2025

(54) SLIDING CONVOLUTIONAL NEURAL NETWORK

(71) Applicant: STMicroelectronics International N.V., Geneva (CH)

(72) Inventors: Federico RIZZARDINI, SETTIMO MILANESE (IT); Giacomo TURATI, Cusano Milanino (IT)

(73) Assignee: STMicroelectronics International N.V., Geneva (CH)

(21) Appl. No.: 18/472,063

(22) Filed: Sep. 21, 2023

(51) Int. Cl. G06N 3/0464

(52) U.S. Cl. CPC G06N 3/0464

(57) ABSTRACT

A device includes a sensor and processing circuitry. The sensor, in operation, generates a sequence of data samples. The processing circuitry, in operation, implements a sliding convolutional neural network (SCNN) having a plurality of layers to generate classification results based on the sequence of data samples. The SCNN sequentially processes the sequence of data samples, the sequentially processing the sequence of data samples including, for each received sample of a set of received data samples of the sequence of data samples, iteratively updating partial results of an inference of a first layer of the plurality of layers based on a respective patch of data samples of the sequence of data samples. The respective patch of data samples includes the received data sample. The classification results may be used to generate control signals, such as by the sensing device or a host processor coupled to the sensing device.

### BACKGROUND

### Technical Field

The present disclosure generally relates to machine learning (e.g., an artificial neural network (ANN), such as a convolutional neural network (CNN)).

### Description of the Related Art

Various computer vision, speech recognition, and signal processing applications may benefit from the use of machine learning models, which may quickly perform hundreds, thousands, or even millions of concurrent operations. Machine learning models, as discussed in this disclosure, may fall under the technological titles of artificial intelligence, neural networks, probabilistic inference engines, accelerators, and the like. Such machine learning models may include or otherwise utilize CNNs, such as deep convolutional neural networks (DCNN). A DCNN is a computer-based tool that processes large quantities of data and adaptively “learns” by conflating proximally related features within the data, making broad predictions about the data, and refining the predictions based on reliable conclusions and new conflations. The DCNN is arranged in a plurality of “layers”, and different types of operators may be applied at each layer.

### BRIEF SUMMARY

In an embodiment a device comprises a sensor and processing circuitry coupled to the sensor. The sensor, in operation, generates a sequence of data samples. The processing circuitry, in operation, implements a sliding convolutional neural network (SCNN) having a plurality of layers to generate classification results based on the sequence of data samples. The SCNN sequentially processes the sequence of data samples to generate the classification results. The sequentially processing the sequence of data samples includes, for each received sample of a set of received data samples of the sequence of data samples, iteratively updating partial results of an inference of a first layer of the plurality of layers based on a respective patch of data samples of the sequence of data samples, the respective patch of data samples including the received data sample.

In an embodiment, a system comprises a host device and a sensing device coupled to the host device. The sensing device, in operation, generates a sequence of data samples and implements a sliding convolutional neural network (SCNN) having a plurality of layers to generate classification results based on the sequence of data samples. The SCNN sequentially processes the sequence of data samples. The sequentially processing the sequence of data samples includes, for each received sample of a set of received data samples of the sequence of data samples, iteratively updating partial results of an inference of a first layer of the plurality of layers based on a respective patch of data samples of the sequence of data samples, the respective patch of data samples including the received data sample.

In an embodiment, a method comprises generating, using a sensor of an integrated circuit, a sequence of data samples, and implementing, using processing circuitry of the integrated circuit, a sliding convolutional neural network (SCNN) having a plurality of layers. The sequence of data samples is sequentially processed using the SCNN, and classification results are generated based on the processing of the sequence of data samples using the SCNN. The sequentially processing the sequence of data samples includes, for each received sample of a set of received data samples of the sequence of data samples, iteratively updating partial results of an inference of a first layer of the plurality of layers based on a respective patch of data samples of the sequence of data samples, the respective patch of data samples including the received data sample.

In an embodiment, a non-transitory computer-readable medium's contents cause a sensing device to perform a method. The method comprises generating a sequence of data samples, implementing a sliding convolutional neural network (SCNN) having a plurality of layers, and sequentially processing the sequence of data samples using the SCNN. Classification results are generated based on the processing of the sequence of data samples using the SCNN. The sequentially processing the sequence of data samples includes, for each received sample of a set of received data samples of the sequence of data samples, iteratively updating partial results of an inference of a first layer of the plurality of layers based on a respective patch of data samples of the sequence of data samples, the respective patch of data samples including the received data sample.

### BRIEF DESCRIPTION OF THE SEVERAL VIEWS OF THE DRAWINGS

One or more embodiments are described hereinafter with reference to the accompanying drawings.

FIG. 1 is a conceptual diagram illustrating a digit recognition task.

FIG. 2 is a conceptual diagram illustrating an image recognition task.

FIG. 3 is a conceptual diagram illustrating a human activity classification task based on motion sensor data samples.

FIG. 4 is a conceptual diagram illustrating an example of a CNN.

FIG. 5 is a conceptual diagram illustrating an example convolutional layer of a CNN.

FIG. 6 is a conceptual diagram illustrating example strides of convolutional layers of a CNN.

FIG. 7 is a conceptual diagram illustrating application of padding of an input feature map to preserve height and width dimensions during a convolution.

FIG. 8 is a conceptual diagram illustrating loading of feature data in batches.

FIG. 9 is a conceptual diagram illustrating processing of a convolution in batches.

FIG. 10 is a functional block diagram of an embodiment of an electronic device or system employing a sliding convolutional neural network.

FIG. 11 is a conceptual diagram illustrating an architecture of a CNN for time series prediction.

FIG. 12 illustrates an embodiment of a method of using inference windowing to generate an inference of a CNN based on a time sequence of received data samples.

FIG. 13 illustrates an embodiment of a method of using a sliding convolutional neural network (SCNN) to generate a prediction based on a time sequence of received data samples.

FIG. 14 is a conceptual diagram illustrating the iterative processing of a convolutional or a pooling layer of an SCNN as series of input samples are received.

FIG. 15 illustrates an embodiment of a method of generating an output of a convolutional or pooling layer using a SCNN implementation of the layer.

FIG. 16 illustrates an embodiment of a method of generating an output of a convolutional or pooling layer using a SCNN implementation of the layer, when striding is to be applied to the data samples.

FIG. 17 is a conceptual diagram illustrating a first dense layer of a CNN implemented using a SCNN for two sample iterations.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, with or without one or more of these specific details, or with other methods, components, devices, materials, etc. In other instances, well-known structures or components that are associated with the environment of the present disclosure, including but not limited to interfaces, power supplies, physical component layout, accelerometers, gyroscopes, convolutional accelerators, Multiply-ACcumulate (MAC) circuitry, etc., in a hardware accelerator environment, have not been shown or described in order to avoid unnecessarily obscuring descriptions of the embodiments. Additionally, the various embodiments may be methods, systems, devices, computer program products, etc.

Throughout the specification, claims, and drawings, the following terms take the meaning associated herein, unless the context indicates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context indicates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context indicates otherwise. In addition, throughout the specification, the meaning of “a,” “an,” and “the” include singular and plural references.

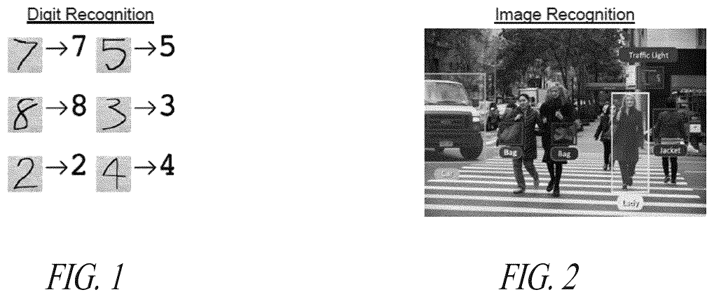

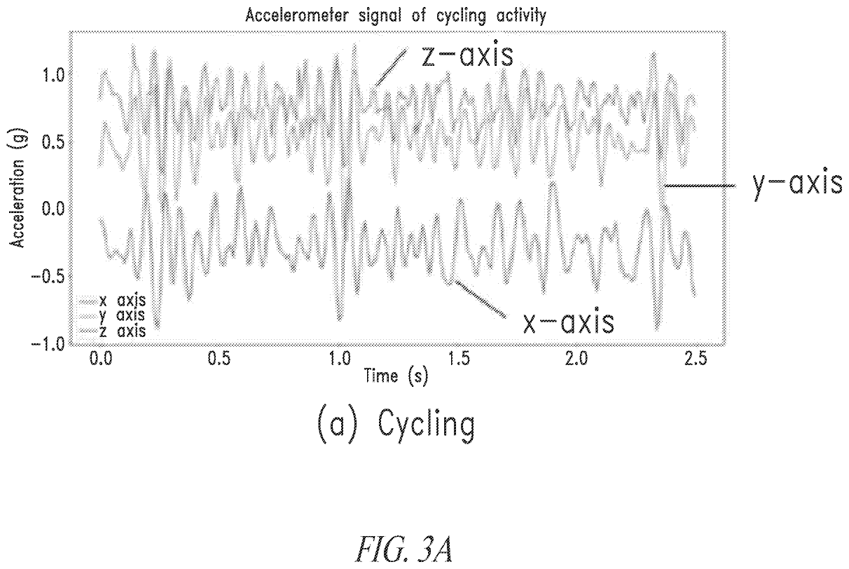

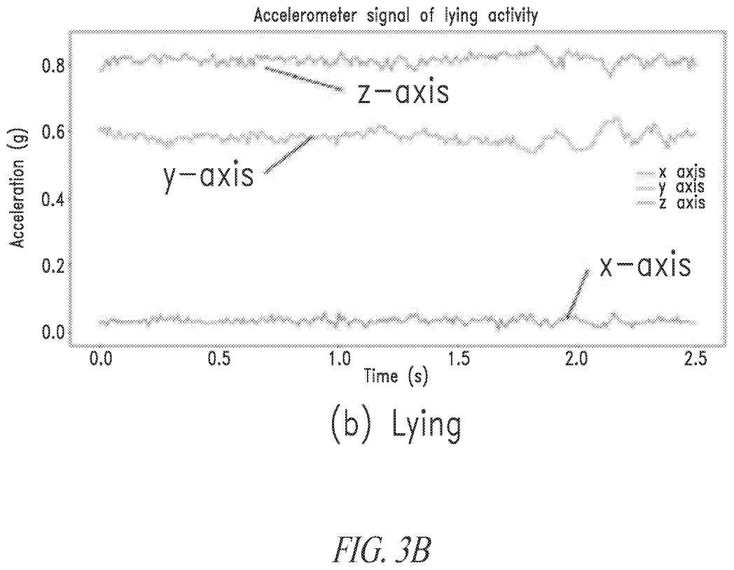

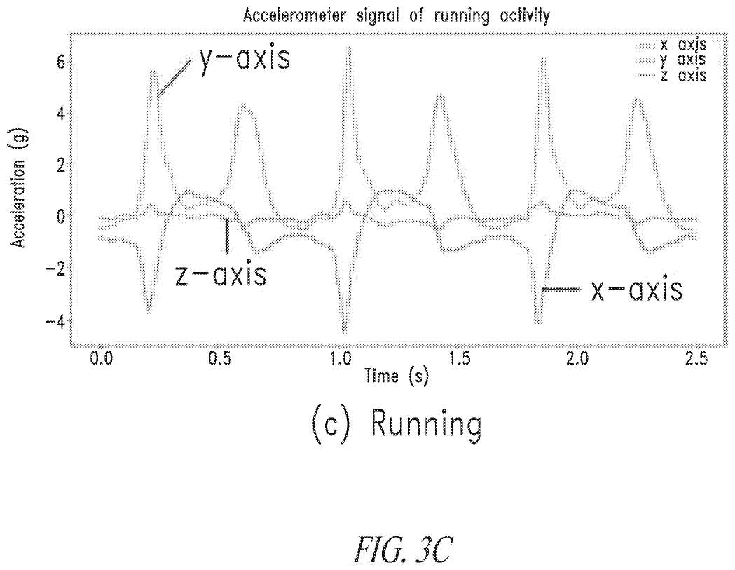

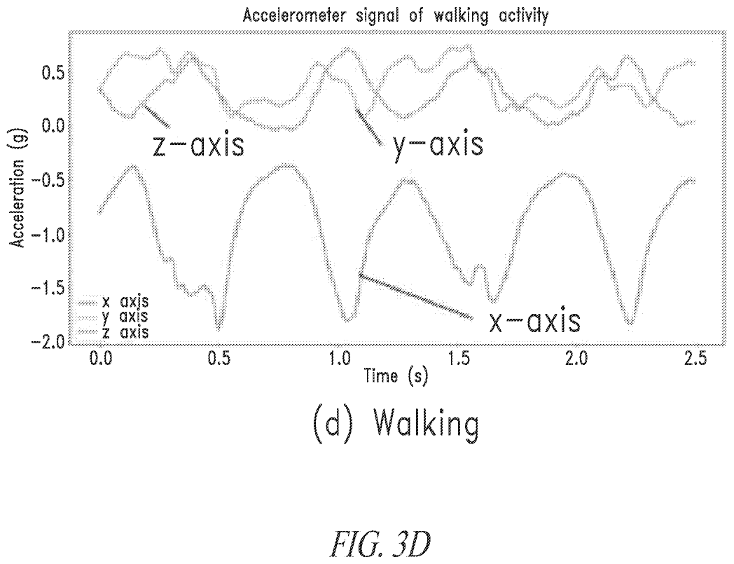

CNNs are particularly suitable for recognition tasks, such as recognition of numbers or objects in images, and may provide highly accurate results. FIG. 1 is a conceptual diagram illustrating a digit recognition task. FIG. 2 is a conceptual diagram illustrating an image recognition task. FIG. 3 is a conceptual diagram illustrating a human activity recognition or classification task based on accelerometer sensor data.

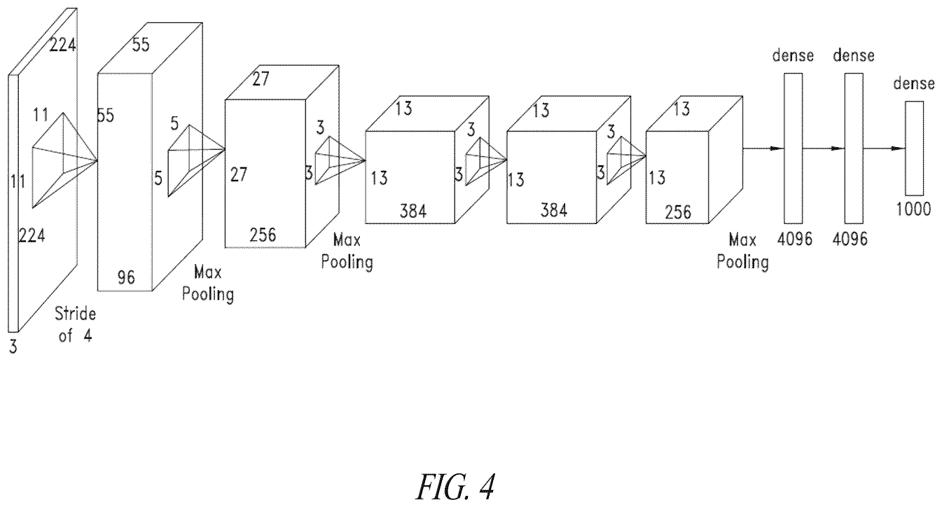

CNNs are specific types of deep neural networks (DNN) with one or multiple layers which perform a convolution on a multi-dimensional feature data tensor (e.g., a three-dimensional data tensor having a size of width×height×depth elements). The first layer is an input layer and the last layer is an output layer. The intermediate layers may be referred to as hidden layers. The most used layers are convolutional layers, fully connected or dense layers, and pooling layers (max pooling, average pooling, etc.). Data exchanged between layers are called features or activations. Each layer also has a set of learnable parameters typically referred to as weights or kernels. FIG. 4 is a conceptual diagram illustrating an example of an CNN, that is AlexNet. The illustrated CNN has a set of convolutional layers interleaved with max pooling layers, followed by a set of fully connected or dense layers.

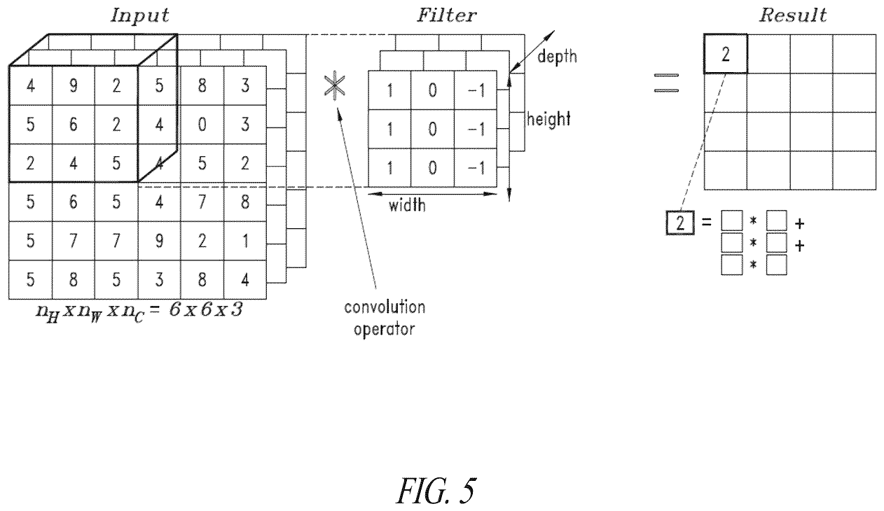

The parameters of a convolutional layer include a set of learnable filters referred to as kernels. Each kernel has three dimensions, height, width and depth. The height and width are typically limited in range (e.g., [1, 11]). The depth typically extends to the full depth of an input feature data. Each kernel slides across the width and the height of the input features and a dot product is computed. At the end of the process a result is obtained as a set of two-dimensional feature maps. In a convolutional layer, many kernels are applied to an input feature map, each of which produces a different feature map as a result. The depth of the output feature tensors is also referred to as the number of output channels. FIG. 5 is a conceptual diagram illustrating the application of a kernel to a feature map, producing a two-dimensional feature map having a height of 4 and a width of 4.

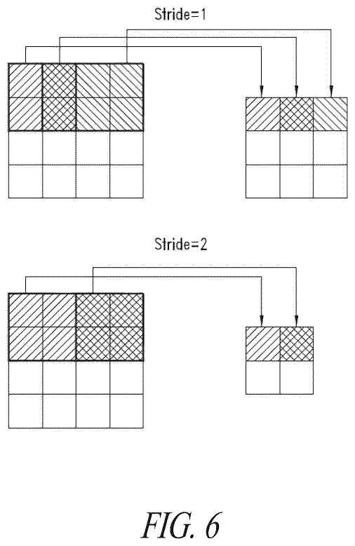

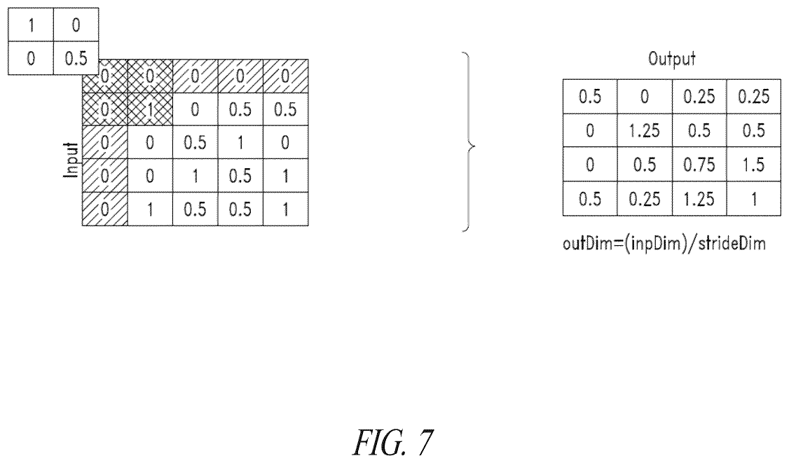

Convolutional layers also may have other parameters, which may be defined for the convolutional layer, rather than learned parameters. Such parameters may be referred to as hyper-parameters. For example, a convolutional layer may have hyper-parameters including stride and padding hyper-parameters. The stride hyper-parameter indicates a step-size used to slide kernels across an input feature map. FIG. 6 is a conceptual diagram comparing a stride of 1 and a stride of 2. The padding hyper-parameter indicate a number of zeros to be added along the height, the width or the height and width of the input feature map. The padding parameters may be used to control the size of an output feature map generated by the convolution. FIG. 7 is a conceptual diagram illustrating an application of padding to an input feature map.

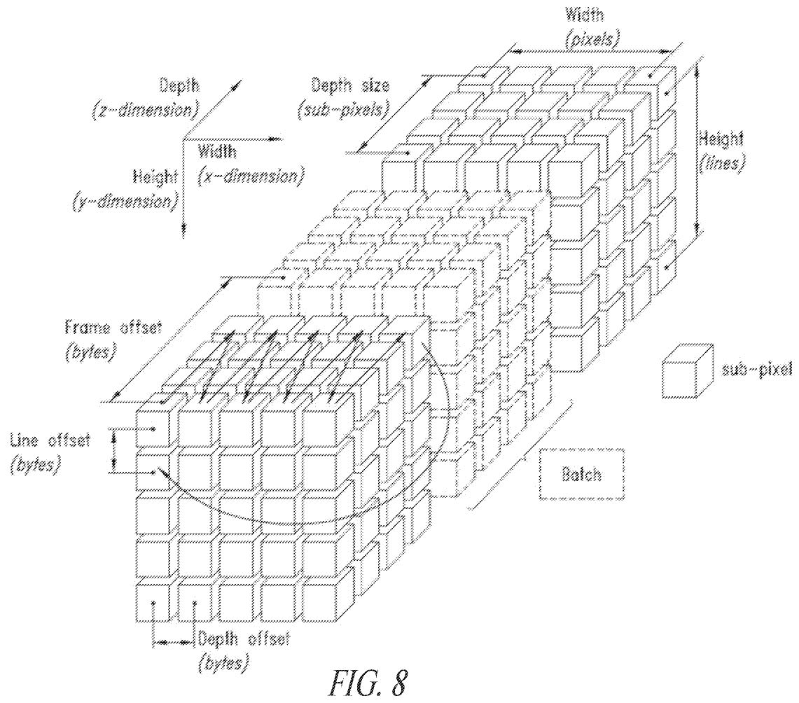

The feature data of a convolutional layer may have hundreds or even thousands of channels, with the number of channels corresponding to the depth of the feature data and of the kernel data. For this reason, feature and kernel data are often loaded into memory in batches. FIG. 8 is a conceptual diagram illustrating the concept of loading feature data in batches. The feature data is split along the depth dimension into batches, with each batch of feature data having the same height, width and depth. The kernel depth is generally the same as the depth of the input feature map, so similar issues are addressed by batching.

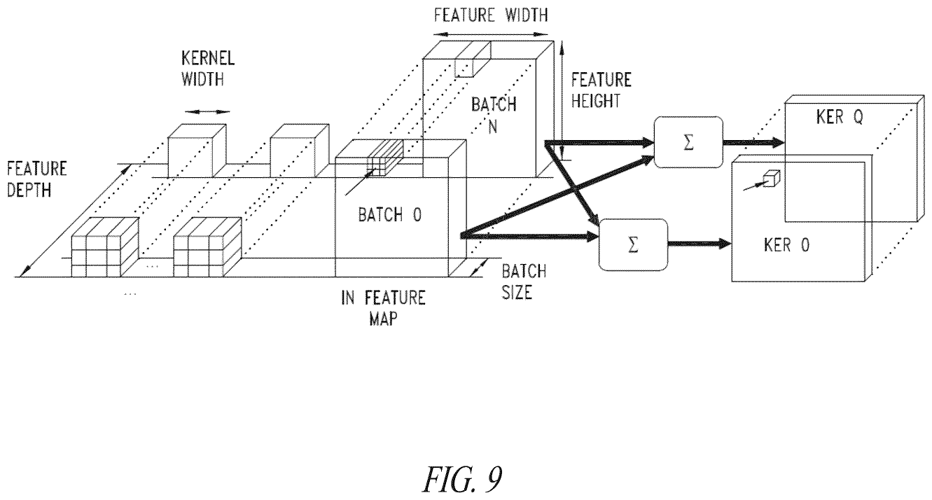

As illustrated, the batches have a height of 5, a width of 5, and a depth of 4. Batches are typically written into memory sequentially, with writing of a first batch being completed before beginning the writing of a second batch. The arrows in FIG. 8 illustrate an example order in which data of a batch is written into memory. A similar batching process is typically applied to the kernel data, with each batch of the kernel data having the same kernel height and kernel width, and the same depth as the batches of feature data. Each batch of feature data is convolved with a related batch of kernel data, and a feedback mechanism is employed to accumulate the results of the batches. The conceptual diagram of FIG. 9 illustrates the concept of batch processing of a convolution. As can be seen, the computations performed by a CNN, or by other neural networks, often include repetitive computations over large amounts of data.

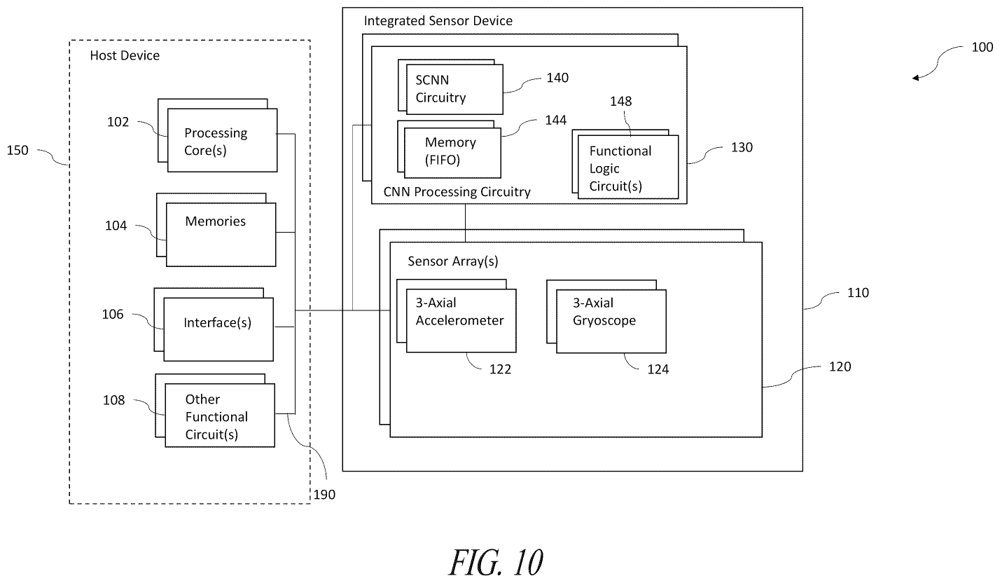

FIG. 10 is a functional block diagram of an embodiment of an electronic device or system 100 of the type to which described embodiments may apply. The system 100 comprises one or more processing cores or circuits 102. The processing cores 102 may comprise, for example, one or more processors, a state machine, a microprocessor, a programmable logic circuit, discrete circuitry, logic gates, registers, etc., and various combinations thereof. The processing cores may control overall operation of the system 100, execution of application programs by the system 100 (e.g., programs which use human activity classification information generated by CNNs (for example, based on inertial sensor data) to generate control or output signals related to the operation of the device), etc.

The system 100 includes one or more memories 104, such as one or more volatile and/or non-volatile memories which may store, for example, all or part of instructions and data related to control of the system 100, applications and operations performed by the system 100, etc. One or more of the memories 104 may include a memory array, general purpose registers, etc., which, in operation, may be shared by one or more processes executed by the system 100.

The system 100 may include one or more interfaces 106 (e.g., wireless communication interfaces, wired communication interfaces, etc.), and one or more other circuits 108, which may include antennas, power supplies, one or more built-in self-test (BIST) circuits, etc., and a main bus system 190. The main bus system 190 may include one or more data, address, power, interrupt, and/or control buses coupled to the various components of the system 100. Proprietary bus systems and interfaces may be employed, such as the Advanced extensible Interface (AXI) bus system. As illustrated, the system 100 includes a host device 150 including the processing cores 102, the memories 104, the interfaces 106 and the other functional circuits 108.

The system 100 includes also one or more integrated sensor devices 110, which as illustrated include one or more sensor arrays 120 (e.g., one or more inertial sensors, such as accelerometers or gyroscopes, image sensors, pressure sensors, temperature sensors, magnetometers, etc., and various combinations thereof), and CNN processing circuitry 130 (e.g., processing circuitry to perform one or more operations associated with implementing a CNN, such as a CNN to recognize or classify human activity based on inertial sensor data, or more generally, a CNN directed to time series prediction or classification based on a time series of data samples). As illustrated, the integrated sensor device 110 includes a sensor array 120 having one or more 3-axial accelerometers 122 and one or more 3-axial gyroscopes 124.

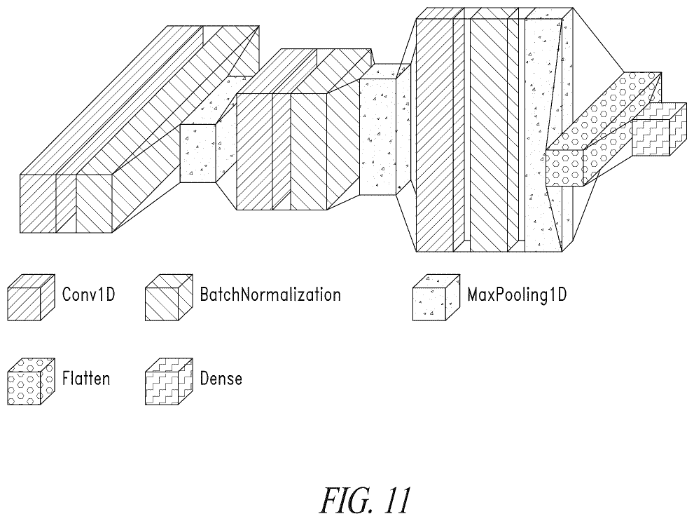

FIG. 11 is a conceptual diagram illustrating an architecture of a CNN for time series prediction. The CNN architecture as illustrated includes one-dimensional convolutional layers (nevertheless, two-dimensional convolutional layers are supported), batch normalization layers, max pooling layers, flattening layers and dense layers. The input of a hidden layer is the output of a previous layer.

The dimensions of the first convolutional layer may correspond to a number of channels c times a window length n, and may be, for example a two-dimensional tensor. A one-dimensional convolutional layer may comprise a set of multi-channel convolutional kernels of size k. Two-dimensional variants may be formed by stacking channels on a row to form a three-dimensional tensor having a dimension of 1×c×n, leading to two-dimensional single-channel kernels. A one-dimensional convolutional operator at time t may be represented as follows:

$$o ( t ) = {\sum }_{i = 1}^{i = c} {\sum }_{j = 1}^{j = k} {x}_{i} ( t + j ) {kern}_{i} ( j )$$

Even if not shown in the formula above, the convolutional operator may include an activation function.

A pooling layer of size p aggregates subsequences of size p by, for example, selecting a maximum value or an average value. The batch normalization layers normalize an input using an estimated mean and variance. The flattening layers reshape the multi-channel input to a single channel output with a compliant dimensionality. A dense layer approximates non-linear functions. Dense layers are usually the last layer in a CNN topology, and frequently perform the classification function. Both convolutional and dense layers may apply bias and activation functions to their outputs. A CNN for time series prediction may frequently having only a single dense layer.

CNNs use convolutional operators extensively, and implementations in integrated sensor devices processing sequentially received data samples (e.g., sequences of sensor data samples) need to be able to process the data as it is received, or store the data until it can be processed. Employing large input buffer memories to store data samples until the samples can be processed is undesirable, both in terms of latency of receiving the results, and the costs associated with storing the data in memory (e.g., the cost of the input buffer memory in area and power, and the cost associated with managing the storage of the data). This is particularly applicable in resource constrained applications. In addition, there is a substantial risk of data loss if new data samples are received while the processing of the prior samples is incomplete since still ongoing, and the input buffer memory is not large enough to store the new data until it can be processed.

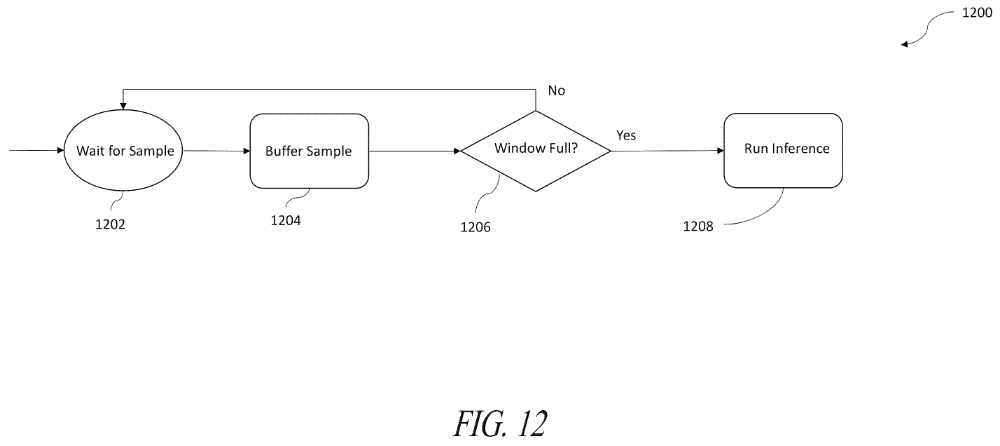

FIG. 12 illustrates an embodiment of a method 1200 of using inference windowing to facilitate generating an inference of a CNN based on a time sequence of received sensor data. The size of an inference window is the number of data samples needed to make an inference, and thus windowing requires a buffer having a size at least as large as the size of the inference window. At 1202, the method 1200 waits for a sample to be received. When a sample is received, the sample is buffered at 1204.

At 1206, the method 1200 checks whether the inference window is full. When it is determined at 1206 that the inference window is not full, the method 1200 returns to 1202 to wait for another sample. When it is determined at 1206 that the inference window is full, the method 1200 proceeds to 1208. At 1208, an inference for the CNN is generated using the samples of the inference window stored in the buffer. After the inference is generated, the buffer may be reset, and the process may be performed on a subsequent sequence of samples. While inference windowing may help to facilitate implementing a CNN on a resource constrained device, there are several drawbacks to the inference windowing approach.

First, there is a danger of samples being lost while the inference of the CNN is being computed unless a buffer substantially larger than the inference window size is employed. This is because, in practice, the generation of a complete inference of a CNN may take a significant amount of time relative to the sample rate. Any samples received while the inference of the CNN is being computed and before the buffer can be reset to store more samples may be lost or overwritten as a new data sample is received. The lost data may have a significant impact on the classifications output by a CNN due to missing information.

Second, the use of processing resources is not evenly distributed in time as the sequence of time samples are received and processed. The generating of the inference of the CNN must wait until the sample window is full. The processing resources needed to perform a complete inference when multiple convolutional operations associated with processing of all the samples of the window are being performed. The use of processing resources is relatively low between the generation of inferences (e.g., managing the storage of received data samples). Uneven processing demand may result in the need for a significant amount of additional circuitry, for example, to perform more convolutional operations in parallel during the generation of an inference, and may make power management more difficult and more resource intensive.

Third, the size of the required input buffer may be quite large, and may be too large as a practical matter to implement on a resource constrained device.

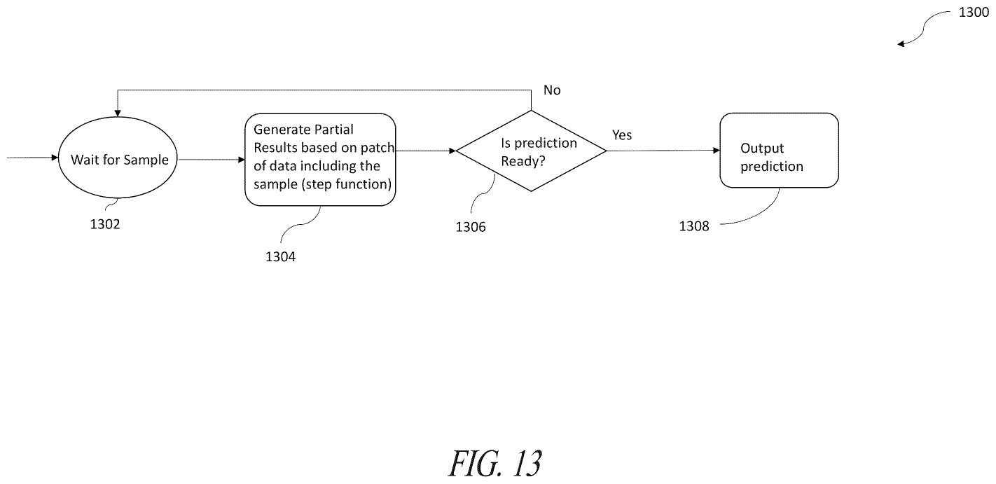

To facilitate performing classifications based on a time series of data samples on resource constrained devices, the CNN processing circuitry 130 of the system 100 of FIG. 10 includes sliding convolutional neural network (SCNN) circuitry 140, which, in operation, implements one or more layers of a CNN as a SCNN, for example, as described below with reference to FIGS. 13-17.

Embodiments of the system 100 of FIG. 10 may include more components than illustrated, may include fewer components than illustrated, may combine components, may separate components into sub-components, and various combination thereof. For example, the functional logic circuits 148 of the integrated sensor device 110 may, in some embodiments, include a wireless interface, and the integrated sensor device 110 may be coupled to a wireless interface 106 of the system 100 instead of being directly coupled to the bus system 190. In another example, the integrated sensor device 110 may include control registers to store configuration information.

FIG. 13 illustrates an embodiment of a method 1300 of using a SCNN to facilitate generating classifications in a resource constrained device based on a time sequence of received sensor data, and for convenience will be described with reference to FIG. 10. In a SCNN, the results of one or more layers of a CNN are iteratively updated as individual samples of the time series of data samples are received.

At 1302, the method 1300 waits for a sample to be received. For example, a data sample may be received by the SCNN circuitry 140 from one of the sensors 122, 124 of the sensor array 120 and stored in a FIFO buffer 144, or a partial output of a prior layer may be received as an input data sample for the current layer, and stored in a FIFO buffer 144 for use by the current layer. When a data sample is received, the method 1300 proceeds from 1302 to 1304, where a patch of data including the sample is processed to generate a partial prediction result, iteratively updating the layer prediction result as each sample is processed. This may be referred to as a step function. The sizes of the patches may be very small relative to the size of the inference window of the embodiment of FIG. 12, as the sizes of the patches only need to be as large as a receptive field or region of input for the convolutional or pooling operator of the layer. For a typical convolutional or pooling layer, the patch size may be, for example, in the order of 3-5 samples. The method 1300 proceeds from 1304 to 1306.

At 1306, the method 1300 checks whether the inference (prediction) of the layer is complete. This may be done, for example, by counting the number of samples processed by the method 1300 at 1304 and comparing the counted number of samples processed to a number of samples, such as a number of samples of an inference window of the layer. When it is determined at 1306 that the prediction is not complete, the method 1300 returns to 1302 to wait for another sample. When it is determined at 1306 that the prediction is complete, the method 1300 proceeds to 1308. At 1308, a last partial prediction or a complete prediction for the layer may be provided, for example, to a subsequent layer or as an output. The process may then be performed on a subsequent sequence of samples. While method 1300 of FIG. 13 is generally described with reference to a single layer, the iterative process may be applied to multiple layers of the CNN, or even to an entire CNN, as each sample is received, with a partial prediction of one layer providing input data for a a subsequent layer of the SCNN (e.g., input data for a patch of a subsequent layer).

The embodiment of the method 1300 of FIG. 13 has several advantages over the embodiment 1200 of FIG. 12 with respect to facilitating implementing a CNN on resource constrained devices.

First, the danger of samples being lost while the inference or prediction of the layer is being generated is significantly reduced. As partial inferences or predictions of the layers are iteratively generated as each data sample is received, the processing time of each iterative step in practice is typically much smaller than the data rate, significantly reducing the likelihood that any samples are received before the patch buffer for the layers are ready to receive a new data sample. Thus, the use of a SCNN to implement a CNN on a resource constrained device facilitates execution of the CNN, and avoiding impacts of lost data on the classifications of the CNN. In some embodiments, there may be no need to include an input data buffer to store the data samples as the samples are received.

Second, as mentioned above, the use of processing resources is more evenly distributed in time as the sequence of time samples are received and processed. This facilitates avoiding the need for parallel processing circuitry to handle a large number of convolutional operations in parallel, as well as simplifying power management and reducing associated resource requirements.

Third, the size of the input buffer needed to implement a CNN using SCNN based processing may be significantly reduced as compared to a window-based processing of a CNN.

In other words, in the embodiment of FIG. 12, samples received from a sensor must be stored until there is sufficient data to run a complete inference of the CNN. The processing to generate the inference occurs after all the needed data samples are received. The time for this processing can be in the order of seconds. This can result in significant data loss unless the input signal can be buffered when the inference of the CNN is running. In the embodiment of FIG. 13, partial results are iteratively generated as the data samples are received, and the iteratively updating may be applied to every layer on the SCNN based on a contribution of a current sample. When the amount of received data samples is sufficient to generate a complete inference of the SCNN, the processing needed to complete the inference is minimal (e.g., typically performing a single iteration of the processing of the latest sample). The processing time to complete the inference is significantly smaller than the time required in the embodiment of FIG. 12. In some embodiments, the use of an input buffer may be avoided entirely due to the distributed processing of the data samples as each sample is received.

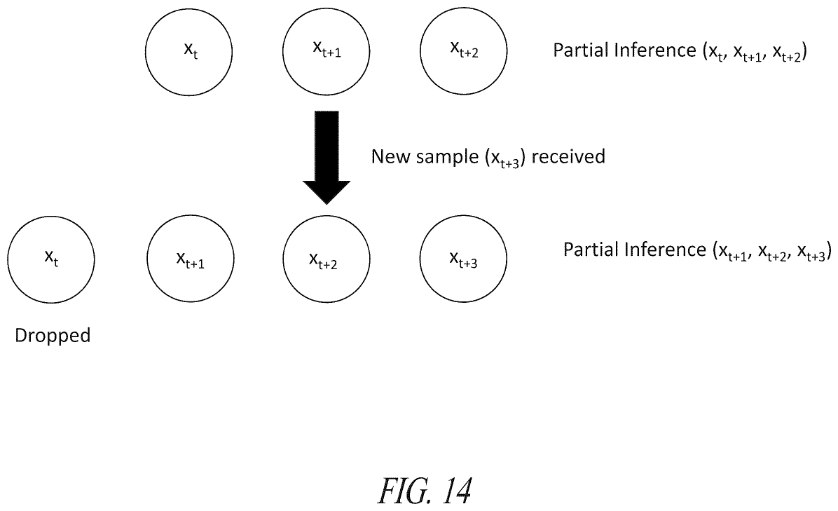

FIG. 14 is a conceptual diagram illustrating the iterative processing of a convolutional or a pooling layer of an SCNN as series of input samples are received, and for convenience will be described with reference to FIG. 10. As illustrated, the patch size of the layer is 3. At a time t+2, a data sample xₜ₊₂ is received and stored in the patch buffer, such as a circular FIFO buffer 144 having a size of the patch. At time t+2, the patch buffer already stores data sample xₜ₊₁ received at time t+1, and data sample xₜ received at time t. Thus, three samples are available for generating a partial result of the layer, and a partial inference is generated based on the samples xₜ, xₜ₊₁, xₜ₊₂. When the patch size is 3, the iterative processing occurs for each received sample of a set of data samples beginning with a sample received at time t+2 (to fill the patch buffer).

At a subsequent time t+3, a data sample xₜ₊₃ is received and shifted into the patch buffer 144, which results in the data sample xₜ being shifted out of the patch buffer and dropped. The patch buffer now stores data sample xₜ₊₁ received at time t+1, data sample xₜ₊₂ received at time t+2, and data sample xₜ₊₃ received at time t+3. Thus, three samples are again available for generating a partial result of the layer, and a partial inference or prediction is generated based on the samples xₜ₊₁, xₜ₊₂, xₜ₊₃. Thus, convolutional and pooling layers may produce an output by applying a layer operator iteratively on buffered local patches.

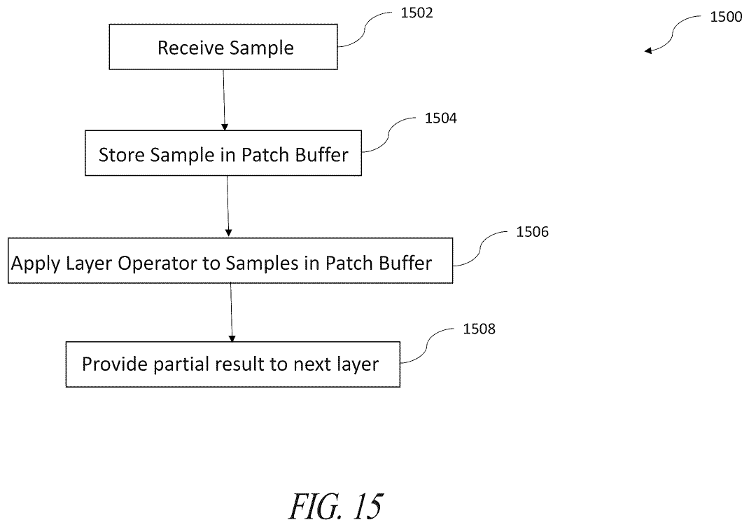

FIG. 15 illustrates an embodiment of a method 1500 of generating an output of a convolutional or pooling layer using a SCNN implementation of the layer, and for convenience will be described with reference to FIGS. 10 and 13. The method 1500 may be viewed as an example implementation of act 1304 of the method 1300 of FIG. 13. At 1502, the method 1500 receives a data sample. For example, a data sample may be received by the SCNN circuitry 140 from one of the sensors 122, 124 of the sensor array 120, or from a prior layer of a CNN implemented using a SCNN. The method 1500 proceeds from 1502 to 1504, where the data sample is stored in a patch buffer, such as a FIFO buffer 144. For example, the data sample may be shifted into a circular buffer having a size of the patch for the layer. The method 1500 proceeds from 1504 to 1506.

At 1506, the method 1500 applies an operator for the layer to the data samples stored in the patch buffer. For example, for a convolutional layer, a convolution of the data samples of the patch and the kernel data for the layer may be performed. For a pooling layer, an aggregation function may be applied to the data samples of the patch, such as determining a maximum value or an average value. The method 1500 proceeds from 1506 to 1508.

At 1508, the method 1500 provides the iterative partial result to the next layer for processing. The method 1500 may return to 1502 from 1508 to wait for the next sample for the next iteration, may reset the patch buffer if the iteration is a last iteration for a sequence of samples for the layer, or various combinations thereof (e.g., to start a new set of iterations for the layer).

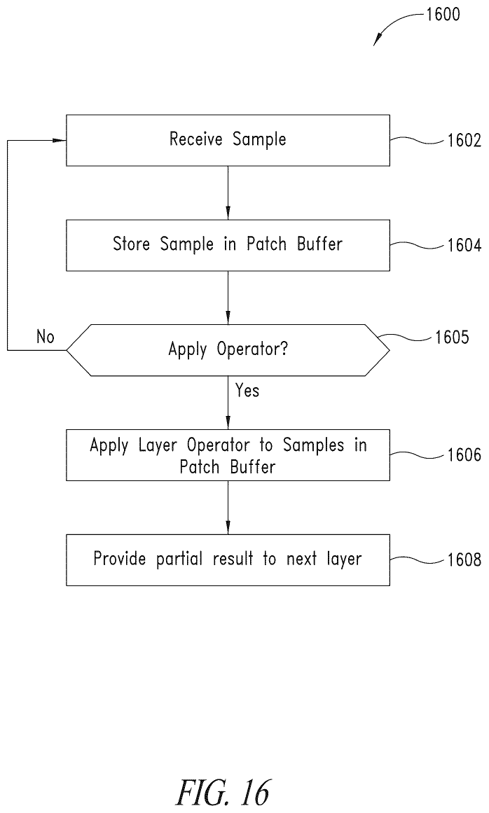

FIG. 16 illustrates an embodiment of a method 1600 of generating an output of a convolutional or pooling layer using a SCNN implementation of the layer, when striding is to be applied to the data samples, and for convenience will be described with reference to FIGS. 10, 13 and 15. Support for a stride parameter s greater than 1 may be added by computing the partial output of a layer every s samples. Striding the feature map is equivalent to downsampling the feature map.

The method 1600 may be viewed as an example implementation of act 1304 of the method 1300 of FIG. 13. At 1602, the method 1600 receives a data sample. For example, a data sample may be received by the SCNN circuitry 140 from one of the sensors 122, 124 of the sensor array 120 or as an iterative result of a prior layer. The method 1600 proceeds from 1602 to 1604.

At 1604, the sample is stored in a patch buffer, such as a FIFO buffer 144. For example, the sample may be shifted into a circular buffer having a size of the patch for the layer.

The method proceeds from 1604 to 1605, where the method 1600 determines whether to apply the operator for the layer to the data samples stored in the patch buffer. This may be done, for example, based on the stride parameter s. For example, if the stride parameter s is 2, every data sample in a sequence of data samples may be stored in the patch buffer, but the operator for the layer is applied one out of two data samples; if the stride parameter s is 3, every data sample of the sequence of data samples may be stored in the patch buffer, but the operator for the layer is applied one out of three data samples; etc. Generalizing, a stride parameter s is implemented by feeding samples (either of signal or of a prior layer output) in the patch buffers for s−1 times without processing (i.e., without applying the layer operator).

When it is determined at 1605 to apply the layer operator to the data samples in the patch buffer, the method 1600 proceeds from 1605 to 1606. When it is not determined at 1605 to apply the layer operator to the data samples in the patch buffer, the method 1600 returns from 1605 to 1602, to wait for a next data sample to be received.

At 1606, an operator for the layer may be applied to the data samples stored in the patch buffer. This may be done, for example, as discussed above with reference to act 1506 of the method 1500 of FIG. 15. The method 1600 proceeds from 1606 to 1608. At 1608, the method 1600 provides the iterative partial result to the next layer for processing. The method 1600 may return to 1602 from 1608 to wait for the next sample for the next iteration, may reset the patch buffer if the iteration is a last iteration for the layer, or various combinations thereof.

Batch normalization and flattening layers may be implemented in an SCNN without using patch buffers, such as circular FIFO buffers. As each data sample to be processed is received, the batch normalization or flattening operator may be applied without buffering the data samples, and the layer may then wait for the next data sample to be processed.

For example, a batch normalization process with a gain factor γ, distribution parameters μ, and σ, and a bias β, with a fixed small hyperparameter ε, may be implemented according to:

$$o = γ ( \frac{x - μ}{\sqrt{{σ}^{2} + ϵ}} ) + β .$$

When a data sample x for the batch normalization layer is received, the incoming sample may be normalized using the above relationship, and the output may be forwarded to the next layer.

In a flattening layer, a multi-dimensional feature map is unrolled into a linear vector output. Usually, a flattening layer is positioned between a feature extraction layer and a classification or dense layer to make the output of the classification layer compatible with the input of the dense layer. A multi-channel input sample may be flattened by passing individually each channel value to the next layer.

At least a first dense layer of a CNN also may be implemented using a SCNN, and as discussed above with reference to FIG. 11, a common implementation of a CNN for time series prediction may have only a single dense layer. Dense layers are often referred to a fully connected layers because each of the S neurons in the layer has a direct connection with every element layer input. During the training, the dense layer learns the matrix of weights W of connections and bias vector b to map the input on O components by computing:

$$o = f ( Wx + b ) .$$

The function ƒ may possibly be a non-linear activation function.

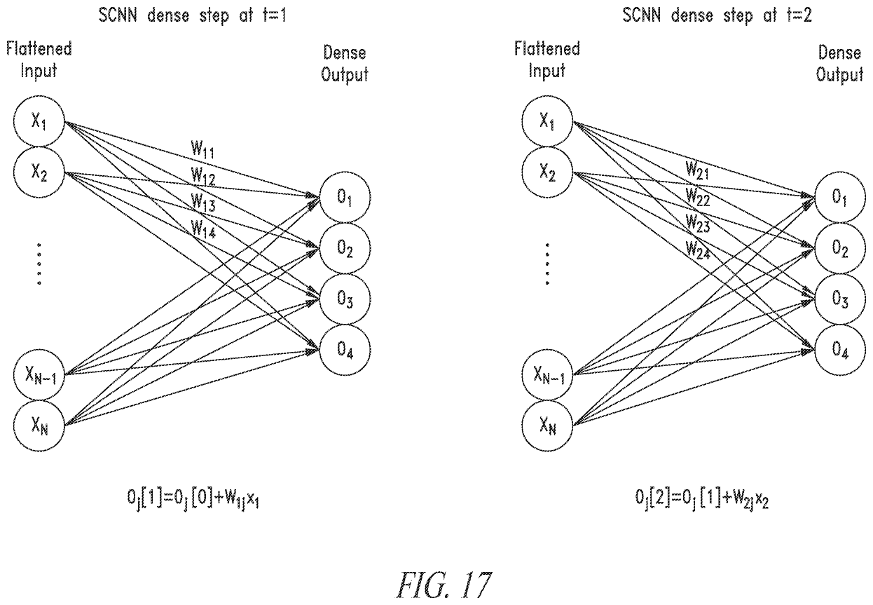

If a CNN having a single dense layer is considered, the sample-by-sample logic of the SCNN can be extended to implement the CNN entirely as a SCNN. FIG. 17 is a conceptual diagram illustrating a first dense layer of a CNN implemented using a SCNN for two sample iterations. Every neuron status oⱼ is initialized with a bias bⱼ when the dense layer is reset at the end of an inference window. When a new input sample xₜ is received from the flattening layer (see FIG. 11) of the CNN, the output of the dense layer may be updated according to:

$${o}_{j} [ t ] = {o}_{j} [ t - 1 ] + {W}_{j , t} {x}_{t}$$

where W_{j,t} is the weight connecting input xₜ and neuron oⱼ. As illustrating on the left side of FIG. 17, when a first input sample x₁ to the dense layer from the flattening layer is received, the partial output of the dense layer may be generated according to:

$${o}_{j} [ 1 ] = {o}_{j} [ 0 ] + {W}_{j , 1} {x}_{1} .$$

As illustrating on the right side of FIG. 17, when a second input sample x₂ to the dense layer from the flattening layer is received, the partial output of the dense layer may be generated according to:

$${o}_{j} [ 2 ] = {o}_{j} [ 2 ] + {W}_{j , 2} {x}_{2} .$$

After the processing of N samples, where N denotes the inference window size, activation functions of dense layer neurons can be computed and the softmax operator can be applied to produce the output vector representing the probability that the just processed window has label j. Thus, a full SCNN implementation of a CNN may be implemented using a resource constrained device, such as the integrated sensor device 110 of FIG. 10.

Embodiments of the foregoing processes and methods may contain additional acts not shown in FIGS. 12-16, may not contain all of the acts shown in FIGS. 12-16, may perform acts shown in FIGS. 12-16 in various orders, may combine acts, may split acts into separate acts, and may be otherwise modified in various respects. For example, FIG. 13 may be modified to implement multiple layers of a CNN as a SCNN.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

In an embodiment a device comprises a sensor and processing circuitry coupled to the sensor. The sensor, in operation, generates a sequence of data samples. The processing circuitry, in operation, implements a sliding convolutional neural network (SCNN) having a plurality of layers to generate classification results based on the sequence of data samples. The SCNN sequentially processes the sequence of data samples to generate the classification results. The sequentially processing the sequence of data samples includes, for each received sample of a set of received data samples of the sequence of data samples, iteratively updating partial results of an inference of a first layer of the plurality of layers based on a respective patch of data samples of the sequence of data samples, the respective patch of data samples including the received data sample.

In an embodiment, sequentially processing the sequence of data samples includes determining when the updated partial results correspond to a complete inference of the SCNN. In an embodiment, the set of received samples is a subset of received samples associated with the complete inference of the SCNN. In an embodiment, the iteratively updating the partial results of the first layer comprises applying a stride parameter.

In an embodiment, the sequentially processing the sequence of data samples includes, for each received sample of the set of received data samples of the sequence of data samples, iteratively updating partial results of a second layer of the SCNN based on the iteratively updated partial results of the first layer. In an embodiment, the sequentially processing the sequence of data samples includes, for each received sample of the set of received data samples of the sequence of data samples, iteratively updating partial classification results of the SCNN.

In an embodiment, the sequentially processing the sequence of data samples includes, for each received sample of the set of received data samples of the sequence of data samples, iteratively updating partial classification results of the SCNN.

In an embodiment, the sequentially processing the sequence of data samples includes, for each received sample of the set of received data samples of the sequence of data samples, iteratively updating partial results of multiple layers of the plurality of layers of the SCNN based on the iteratively updated partial results of the first layer. In an embodiment, the processing circuitry comprises a memory, which, in operation, maintains respective circular FIFO buffers for each of the multiple layers, each circular FIFO buffer having a size of a data patch associated with an iterative update operation associated with the respective layer. In an embodiment, a last layer of the multiple layers is a dense layer.

In an embodiment, the processing circuitry comprises: a memory, which, in operation, maintains a circular FIFO buffer associated with the first layer, the circular FIFO buffer having a size of a data patch associated with an iterative update operation associated with the first layer.

In an embodiment, the device comprises an integrated circuit, wherein the sensor and the processing circuitry are embedded in the integrated circuit.

In an embodiment, the processing circuitry, in operation, generates one or more control signals based on the classification results.

In an embodiment, a system comprises a host device and a sensing device coupled to the host device. The sensing device, in operation, generates a sequence of data samples and implements a sliding convolutional neural network (SCNN) having a plurality of layers to generate classification results based on the sequence of data samples. The SCNN sequentially processes the sequence of data samples. The sequentially processing the sequence of data samples includes, for each received sample of a set of received data samples of the sequence of data samples, iteratively updating partial results of an inference of a first layer of the plurality of layers based on a respective patch of data samples of the sequence of data samples, the respective patch of data samples including the received data sample.

In an embodiment, the sensing device comprises one or more sensors, which, in operation, generate one or more sequences of data samples; and processing circuitry coupled to the one or more sensors, wherein the processing circuitry, in operation, implements the SCNN. In an embodiment, sequentially processing the sequence of data samples includes determining when the updated partial results of the inference of the layer correspond to a complete inference of the SCNN. In an embodiment, the sequentially processing the sequence of data samples includes, for each received sample of the set of received data samples of the sequence of data samples, iteratively updating partial classification results of the SCNN.

In an embodiment, the sequentially processing the sequence of data samples includes, for each received sample of the set of received data samples of the sequence of data samples, iteratively updating partial results of multiple layers of the plurality of layers of the SCNN based on the iteratively updated partial results of the first layer. In an embodiment, the processing circuitry comprises a memory, which, in operation, maintains respective circular FIFO buffers for each of the multiple layers, each circular FIFO buffer having a size of a data patch associated with an iterative update operation associated with the respective layer. In an embodiment, a last layer of the multiple layers is a dense layer.

In an embodiment, the SCNN, in operation, generates classification results based on the sequence of data samples; and the host device, in operation, generates one or more control signals based on the classification results.

In an embodiment, a method comprises generating, using a sensor of an integrated circuit, a sequence of data samples, and implementing, using processing circuitry of the integrated circuit, a sliding convolutional neural network (SCNN) having a plurality of layers. The sequence of data samples are sequentially processed using the SCNN, and classification results are generated based on the processing of the sequence of data samples using the SCNN. The sequentially processing the sequence of data samples includes, for each received sample of a set of received data samples of the sequence of data samples, iteratively updating partial results of an inference of a first layer of the plurality of layers based on a respective patch of data samples of the sequence of data samples, the respective patch of data samples including the received data sample.

In an embodiment, sequentially processing the sequence of data samples includes determining when the updated partial results of the inference correspond to a complete inference of the SCNN. In an embodiment, the sequentially processing the sequence of data samples includes, for each received sample of the set of received data samples of the sequence of data samples, iteratively updating partial classification results of the SCNN.

In an embodiment, the sequentially processing the sequence of data samples includes, for each received sample of the set of received data samples of the sequence of data samples, iteratively updating partial results of multiple layers of the plurality of layers of the SCNN based on the iteratively updated partial results of the first layer.

In an embodiment, sequentially processing the sequence of data samples includes maintaining respective circular FIFO buffers for each of the multiple layers, each circular FIFO buffer having a size of a data patch associated with an iterative update operation associated with the respective layer.

In an embodiment, the method comprises generating one or more control signals based on the classification results.

In an embodiment, the sequentially processing the sequence of data samples comprises applying a stride parameter.

In an embodiment, a non-transitory computer-readable medium's contents cause a sensing device to perform a method. The method comprises generating a sequence of data samples, implementing a sliding convolutional neural network (SCNN) having a plurality of layers, and sequentially processing the sequence of data samples using the SCNN. Classification results are generated based on the processing of the sequence of data samples using the SCNN. The sequentially processing the sequence of data samples includes, for each received sample of a set of received data samples of the sequence of data samples, iteratively updating partial results of an inference of a first layer of the plurality of layers based on a respective patch of data samples of the sequence of data samples, the respective patch of data samples including the received data sample. In an embodiment, the sequentially processing the sequence of data samples includes, for each received sample of the set of received data samples of the sequence of data samples: iteratively updating partial results of multiple layers of the plurality of layers; and iteratively updating partial classification results of the SCNN. In an embodiment, the contents comprise instructions executable by processing circuitry of the sensing device.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a sensor, which, in operation, generates a sequence of data samples; and
processing circuitry coupled to the sensor, wherein the processing circuitry, in operation, implements a sliding convolutional neural network (SCNN) having a plurality of layers to generate classification results based on the sequence of data samples, wherein the SCNN sequentially processes the sequence of data samples to generate the classification results, the sequentially processing the sequence of data samples including:
for each received sample of a set of received data samples of the sequence of data samples, iteratively updating partial results of an inference of a first layer of the plurality of layers based on a respective patch of data samples of the sequence of data samples, the respective patch of data samples including the received data sample.

2. The device according to claim 1, wherein sequentially processing the sequence of data samples includes determining when the updated partial results correspond to a complete inference of the SCNN.

3. The device according to claim 2, wherein the set of received samples is a subset of received samples associated with the complete inference of the SCNN.

4. The device of claim 3, wherein the iteratively updating the partial results of the first layer comprises applying a stride parameter.

5. The device according to claim 1, wherein the sequentially processing the sequence of data samples includes, for each received sample of the set of received data samples of the sequence of data samples, iteratively updating partial results of a second layer of the SCNN based on the iteratively updated partial results of the first layer.

6. The device according to claim 5, wherein the sequentially processing the sequence of data samples includes, for each received sample of the set of received data samples of the sequence of data samples, iteratively updating partial classification results of the SCNN.

7. The device according to claim 1, wherein the sequentially processing the sequence of data samples includes, for each received sample of the set of received data samples of the sequence of data samples, iteratively updating partial classification results of the SCNN.

8. The device according to 1, wherein the sequentially processing the sequence of data samples includes, for each received sample of the set of received data samples of the sequence of data samples, iteratively updating partial results of multiple layers of the plurality of layers of the SCNN based on the iteratively updated partial results of the first layer.

9. The device according to claim 8, wherein the processing circuitry comprises:
a memory, which, in operation, maintains respective circular FIFO buffers for each of the multiple layers, each circular FIFO buffer having a size of a data patch associated with an iterative update operation associated with the respective layer.

10. The device according to claim 8, wherein a last layer of the multiple layers is a dense layer.

11. The device according to claim 1, wherein the processing circuitry comprises:
a memory, which, in operation, maintains a circular FIFO buffer associated with the first layer, the circular FIFO buffer having a size of a data patch associated with an iterative update operation associated with the first layer.

12. The device according to claim 1, comprising:
an integrated circuit, wherein the sensor and the processing circuitry are embedded in the integrated circuit.

13. The device according to claim 1, wherein the processing circuitry, in operation, generates one or more control signals based on the classification results.

14. A system, comprising:
a host device; and
a sensing device coupled to the host device, wherein the sensing device, in operation:
generates a sequence of data samples; and
implements a sliding convolutional neural network (SCNN) having a plurality of layers to generate classification results based on the sequence of data samples, wherein the SCNN sequentially processes the sequence of data samples, the sequentially processing the sequence of data samples including, for each received sample of a set of data samples of the sequence of data samples, iteratively updating partial results of an inference of a first layer of the plurality of layers based on a respective patch of data samples of the sequence of data samples, the respective patch of data samples including the received data sample.

15. The system according to claim 14, wherein the sensing device comprises:
one or more sensors, which, in operation, generate one or more sequences of data samples; and
processing circuitry coupled to the one or more sensors, wherein the processing circuitry, in operation, implements the SCNN.

16. The system according to claim 15, wherein sequentially processing the sequence of data samples includes determining when the updated partial results of the inference of the layer correspond to a complete inference of the SCNN.

17. The system according to claim 16, wherein the sequentially processing the sequence of data samples includes, for each received sample of the set of received data samples of the sequence of data samples, iteratively updating partial classification results of the SCNN.

18. The system according to 15, wherein the sequentially processing the sequence of data samples includes, for each received sample of the set of received data samples of the sequence of data samples, iteratively updating partial results of multiple layers of the plurality of layers of the SCNN based on the iteratively updated partial results of the first layer.

19. The system according to claim 18, wherein the processing circuitry comprises:
a memory, which, in operation, maintains respective circular FIFO buffers for each of the multiple layers, each circular FIFO buffer having a size of a data patch associated with an iterative update operation associated with the respective layer.

20. The system according to claim 18, wherein a last layer of the multiple layers is a dense layer.

21. The system according to claim 15, wherein,
the SCNN, in operation, generates classification results based on the sequence of data samples; and
the host device, in operation, generates one or more control signals based on the classification results.

22. A method, comprising:
generating, using a sensor of an integrated circuit, a sequence of data samples;
implementing, using processing circuitry of the integrated circuit, a sliding convolutional neural network (SCNN) having a plurality of layers;
sequentially processing the sequence of data samples using the SCNN; and
generating classification results based on the processing of the sequence of data samples using the SCNN, wherein the sequentially processing the sequence of data samples includes, for each received sample of a set of received data samples of the sequence of data samples, iteratively updating partial results of an inference of a first layer of the plurality of layers based on a respective patch of data samples of the sequence of data samples, the respective patch of data samples including the received data sample.

23. The method according to claim 22, wherein sequentially processing the sequence of data samples includes determining when the updated partial results of the inference correspond to a complete inference of the SCNN.

24. The method according to claim 23, wherein the sequentially processing the sequence of data samples includes, for each received sample of the set of received data samples of the sequence of data samples, iteratively updating partial classification results of the SCNN.

25. The method according to 22, wherein the sequentially processing the sequence of data samples includes, for each received sample of the set of received data samples of the sequence of data samples, iteratively updating partial results of multiple layers of the plurality of layers of the SCNN based on the iteratively updated partial results of the first layer.

26. The method according to claim 22, wherein the sequentially processing the sequence of data samples includes maintaining respective circular FIFO buffers for each of the multiple layers, each circular FIFO buffer having a size of a data patch associated with an iterative update operation associated with the respective layer.

27. The method according to claim 22, comprising:
generating one or more control signals based on the classification results.

28. The method according to claim 22, wherein the sequentially processing the sequence of data samples comprises:
applying a stride parameter.

29. A non-transitory computer-readable medium having contents which cause a sensing device to perform a method, the method comprising:
generating a sequence of data samples;
implementing a sliding convolutional neural network (SCNN) having a plurality of layers;
sequentially processing the sequence of data samples using the SCNN; and
generating classification results based on the processing of the sequence of data samples using the SCNN, wherein the sequentially processing the sequence of data samples includes, for each received sample of a set of received data samples of the sequence of data samples, iteratively updating partial results of an inference of a first layer of the plurality of layers based on a respective patch of data samples of the sequence of data samples, the respective patch of data samples including the received data sample.

30. The non-transitory computer-readable medium of claim 29, wherein the sequentially processing the sequence of data samples includes, for each received sample of the set of received data samples of the sequence of data samples:
iteratively updating partial results of multiple layers of the plurality of layers; and
iteratively updating partial classification results of the SCNN.

31. The non-transitory computer-readable medium of claim 29, wherein the contents comprise instructions executable by processing circuitry of the sensing device.
